(19) United States
(12) Patent Application Publication
(10) Pub. No.: US 2011/0213748 A1
(43) Pub. Date: Sep. 1, 2011

(54) INFERENCE APPARATUS AND INFERENCE METHOD FOR THE SAME

(75) Inventors: Masami Kawagishi, Yokohama-shi (JP); Ryo Ishikawa, Kawasaki-shi (JP)

(73) Assignee: CANON KABUSHIKI KAISHA, Tokyo (JP)

(21) Appl. No.: 13/012,354

(22) Filed: Jan. 24, 2011

(30) Foreign Application Priority Data
Mar. 1, 2010 (JP) 2010-044633

(51) Int. Cl. G06N 5/04

(52) U.S. Cl. 706/52; 706/54

(57) ABSTRACT

An inference apparatus that infers a class of a case is provided. The apparatus includes an inference unit configured to infer a class of a case with use of an inference device and an evaluation unit configured to, based on a result of inference performed by the inference device with respect to a known case that is similar to an unknown case, evaluate a result of inference with respect to the unknown case.

### BACKGROUND OF THE INVENTION

1. Field of the Invention

The present invention relates to technology for inferring the class of data whose class is unknown, and in particular to technology for evaluating the reliability of the inference.

2. Description of the Related Art

As one example of technology for processing data with use of a computer, there is known to be inference technology in which a group of cases whose classes are known (hereinafter, referred to as “known cases”) is analyzed, and the class to which a case whose class is unknown (hereinafter, referred to as an “unknown case”) belongs is inferred with use of the extracted knowledge. Such inference technology is used in, for example, a decision making support system in the field of medicine.

Here, “inference” refers to processing in which, when a case targeted for inference can be classified into any of several concepts, characteristic values (may also be called “patterns”) that have been obtained are associated with one of the concepts. Such a “concept” is referred to as a “class” or “category”.

Many inference apparatuses obtain knowledge regarding known cases with use of “supervised learning”. “Supervised learning” is a method in which a group of known cases, each having characteristic values (also called “observation values”), which indicate characteristics of the case, and a class (also called a “label”) to which the case belongs, is used to extract the correspondence between the characteristic values and the classes as knowledge. The extracted knowledge is therefore dependent on the group of cases used in the learning.

Although it is possible to extract complete correspondence between characteristic values and classes as knowledge in a group of known cases, correctly inferring the class of an unknown case that does not match any of the known cases is difficult. It is therefore common to use generalized knowledge so as to be able to correctly infer the class of an unknown case as well. In this case, the extent of the reliability of an inference unit can be obtained by examining whether the class of each known case can be correctly inferred with use of the generalized knowledge. However, this obtained reliability is the overall reliability of the inference unit, and does not indicate the reliability of individual inferences performed with respect to unknown cases.

On the other hand, there have been attempts to infer the class of an unknown case with use of known cases that are similar to the unknown case (also referred to as “similar cases”), and to derive the reliability of each individual inference (respect to each unknown case). For example, Japanese Patent Laid-Open No. 2002-230518 discloses technology for inferring the class of an unknown case based on the class distribution of similar cases. Also, Japanese Patent Laid-Open No. 2003-323601 discloses technology for creating a plurality of partial groups from similar cases, and deriving the reliability of an inference with respect to an unknown case based on the overall class distribution of the similar cases and the class distributions of the partial groups.

### SUMMARY OF THE INVENTION

Japanese Patent Laid-Open No. 2002-230518 contains no disclosure of obtaining how reliable an inference is. Also, in Japanese Patent Laid-Open No. 2003-323601, the reliability of the inference technique for inferring a class based on the class distribution of similar cases is merely derived from the extent of variation in the class distribution. For these reasons, there is the problem that it is difficult for a user to intuitively understand the basis of the reliability. There is also the problem that the reliability of an inference cannot be derived if inference is performed using a different method that is not based on the class distribution of similar cases.

The present invention has been achieved in light of such problems, and provides a mechanism for deriving the reliability of an inference with respect to each unknown case in an inference apparatus.

According to an aspect of the present invention, an inference apparatus that infers a class of a case is provided. The apparatus includes an inference unit configured to infer a class of a case with use of an inference device and an evaluation unit configured to, based on a result of inference performed by the inference device with respect to a known case that is similar to an unknown case, evaluate a result of inference with respect to the unknown case.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a diagram showing the apparatus configuration of an exemplary inference apparatus according to a first embodiment.

FIG. 2 is a diagram showing the basic configuration of an exemplary computer that realizes units of the inference apparatus by software.

FIG. 3 is a flowchart showing an exemplary overall processing procedure according to the first embodiment.

FIG. 4 is a diagram showing an example of presentation information according to the first embodiment.

FIG. 5 is a flowchart showing an exemplary processing procedure for obtaining similar cases according to a second embodiment.

FIG. 6 is a diagram showing an example of presentation information according to the second embodiment.

FIG. 7 is a diagram showing an example of presentation information according to a third embodiment.

### DESCRIPTION OF THE EMBODIMENTS

Below is a detailed description of embodiments of an inference apparatus and method according to the present invention with reference to the attached drawings. It should be noted, however, that the scope of the invention is not intended to be limited to the illustrated examples.

### First Embodiment

An inference apparatus according to the first embodiment obtains characteristic values of an unknown case and infers the class to which the unknown case belongs. The following description takes the example of the case where the inference apparatus is used to obtain a plurality of interpretation findings regarding an abnormal shadow in a lung as characteristic values of an unknown case, and infer the type of abnormal shadow as the class to which the unknown case belongs. The target of inference is of course not intended to be limited to this, and the characteristic values, classes, and the like described hereinafter are all merely examples for describing steps in the processing performed by the inference apparatus.

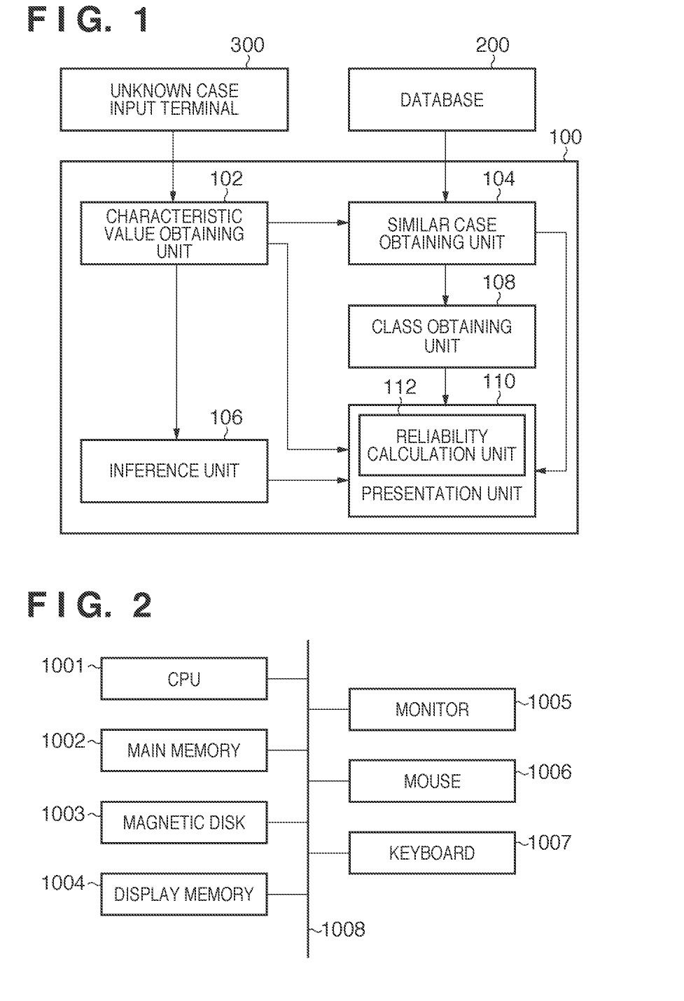

FIG. 1 is a diagram showing the configuration of an exemplary inference apparatus according to the first embodiment. As shown in FIG. 1, an inference apparatus 100 of the present embodiment is connected to a database 200 and an unknown case input terminal 300. The database 200 holds, as known cases, a plurality of cases each having characteristic values (first characteristic values) and a class in pairs that are associated with each other. For each known case, the database 200 also holds a case identifier, characteristic values, a class to which the case belongs (hereinafter, referred to as the “correct class”), and other information (e.g., a representative image or clinical data). All or some of the types (one example of a predetermined parameter) of the characteristic values of the known cases held in the database 200 correspond to the types of characteristic values of an unknown case obtained by a characteristic value obtaining unit 102.

At least one of the known cases held in the database 200 are input to the inference apparatus 100 via a LAN or the like. Alternatively, an external storage apparatus such as an FDD, an HDD, a CD drive, a DVD drive, an MO drive, or a ZIP drive may be connected to the inference apparatus 100, and the inference apparatus 100 may read data from such drives.

In the present embodiment, the unknown case input terminal 300 obtains information regarding an unknown case, which is a case of a disease that is the target of radiogram interpretation, from a server (not shown); examples of the information include the identifier of the case of a disease, a medical image, and clinical data. The unknown case input terminal 300 then displays such information on a monitor in a manner that enables a user to perform radiogram interpretation, and obtains interpretation findings input by the user (e.g., a doctor) as characteristic values. In the present embodiment, the user uses a mouse or a keyboard to input an interpretation finding with respect to the medical image displayed on the monitor. This input processing is realized due to, for example, the unknown case input terminal 300 including a function that enables an interpretation finding to be selected via a GUI with use of a method for assisting the input of an interpretation finding using a template format. In accordance with a request from the user, the unknown case input terminal 300 transmits the characteristic values regarding the unknown case and accompanying data (e.g., the identifier of the case of a disease or a representative image) to the inference apparatus 100 via the LAN or the like.

The inference apparatus 100 includes the characteristic value obtaining unit 102, a similar case obtaining unit 104, an inference unit 106, a class obtaining unit 108, and a presentation unit 110, which will be described hereinafter. The characteristic value obtaining unit 102 obtains characteristic values of an unknown case (second characteristic values) and accompanying data that have been input from the unknown case input terminal 300 to the inference apparatus 100, and outputs the characteristic values and accompanying data to the similar case obtaining unit 104, the inference unit 106, and the presentation unit 110.

The similar case obtaining unit 104 selects, from among known cases obtained from the database 200, one or more known cases that have characteristic values similar to the characteristic values of the unknown case, as similar cases. The similar case obtaining unit 104 then outputs information regarding each of the similar cases (i.e., the case identifier, the characteristic values, the correct class, the representative image, and the like) to the class obtaining unit 108 and the presentation unit 110.

The inference unit 106 infers the class to which the unknown case belongs based on the characteristic values of the unknown case obtained by the characteristic value obtaining unit 102. In the following description, a class obtained by inference processing executed by the inference apparatus 100 is referred to as an “inferred class”. The class obtaining unit 108 obtains information regarding the class of each of the similar cases selected by the similar case obtaining unit 104. In the present embodiment, the class obtaining unit 108 calculates the inferred class of each of the similar cases based on the characteristic values thereof, and obtains the inferred classes as the information regarding the classes of the similar cases.

The presentation unit 110 generates information based on the inferred class of the unknown case obtained by the inference unit 106 and on the information regarding the classes of the similar cases (in the present embodiment, the inferred class of each of the similar cases) obtained by the class obtaining unit 108, and presents the generated information. At least some of the units of the inference apparatus 100 shown in FIG. 1 may be realized as independent apparatuses. Also, these units may be realized by software that realizes their functions. In the present embodiment, these units are each realized by software.

FIG. 2 is a diagram showing the basic configuration of an exemplary computer for realizing the functions of the units shown in FIG. 1 by executing software. A CPU 1001 mainly controls the operation of the components. A main memory 1002 stores a control program executed by the CPU 1001 and provides a work area during the execution of programs by the CPU 1001. A magnetic disc 1003 stores, for example, an operating system (OS), device drivers for peripheral devices, and various types of application software, including a program for performing the later-described processing and the like. A display memory 1004 temporarily stores display data generated by the presentation unit 110.

A monitor 1005 is, for example, a CRT monitor or a liquid crystal monitor, and displays images, text, and the like based on data from the display memory 1004. A mouse 1006 and a keyboard 1007 allow the user to perform input by pointing and to input characters and the like. The above-described components are connected to a common bus 1008 for communicating each other.

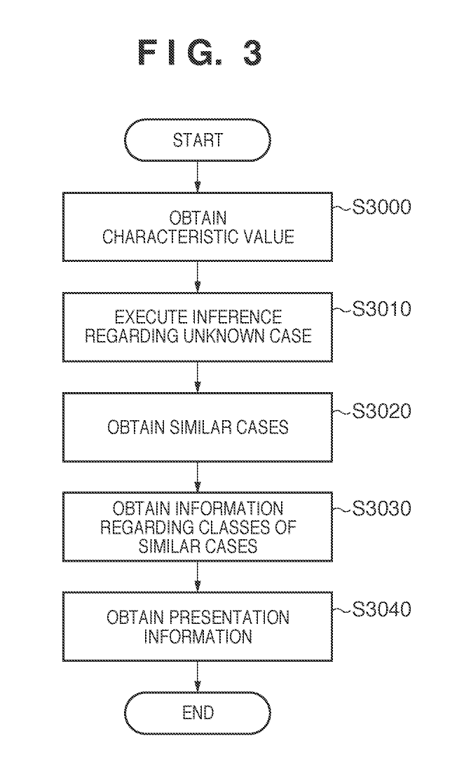

Next is a description of exemplary overall processing performed by the inference apparatus 100 with reference to the flowchart in FIG. 3. The present embodiment is realized by the CPU 1001 executing programs that are stored in the main memory 1002 and realize the functions of the units. In the following description, Iⱼ indicates an interpretation finding, and Iⱼ can take the value of either 1 or 0. Iⱼ=1 means that an interpretation finding exists, and Iⱼ=0 means that an interpretation finding does not exist. Also, in the present embodiment, n types of interpretation findings I₁ to Iₙ are treated as the characteristic values.

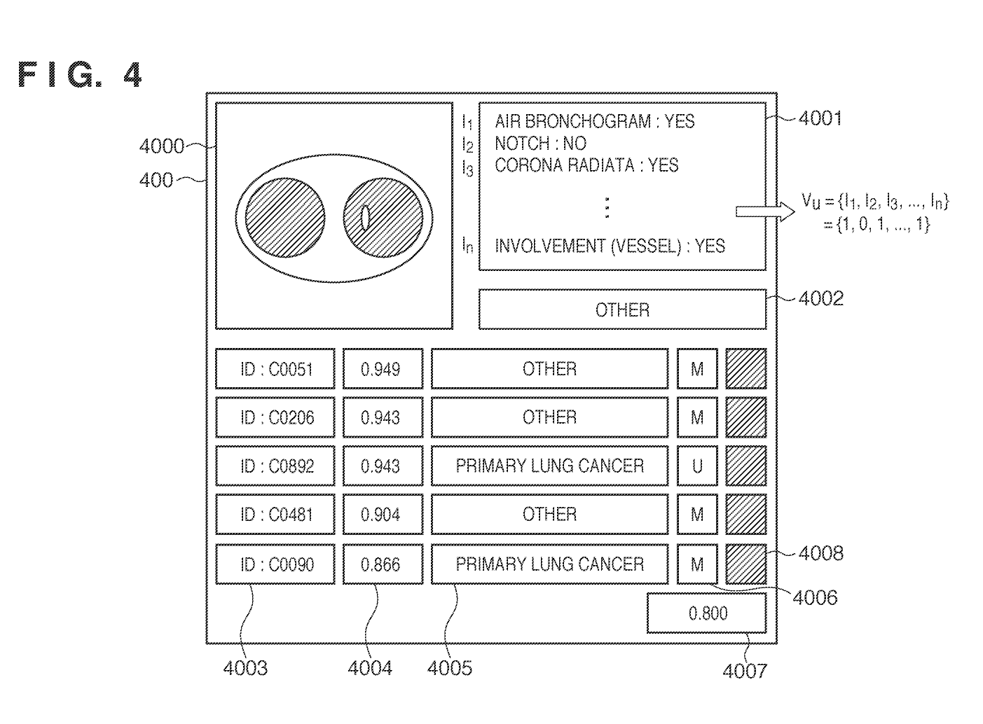

For example, as shown in FIG. 4, “air bronchogram” corresponding to I₁ indicates whether or not (“yes” or “no”) air bronchogram has been found, and “notch” corresponding to I₂ indicates whether or not a notch in an abnormal shadow has been found. Also, “Involvement(vessel)” corresponding to Iₙ indicates whether or not involvement of a blood vessel in an abnormal shadow has been found. Also, in the following description, the characteristic values are indicated by a vector V having Iⱼ as an element, the characteristic values of the unknown case are indicated by Vᵤ, and the characteristic values of the m-th similar case are indicated by Vkm. Also, the type (class) of an abnormal shadow is indicated using the symbol “D”. In the present embodiment, an abnormal shadow can be any of the three types “primary lung cancer”, “metastatic cancer to the lungs”, and “other”, which are indicated by D1, D2, and D3 respectively.

In step S3000, the characteristic value obtaining unit 102 of the inference apparatus 100 in FIG. 1 obtains the characteristic values of an unknown case (second characteristic values) and accompanying data that have been input to the inference apparatus 100. For example, assuming that the information regarding interpretation findings obtained by the inference apparatus 100 in this step is “I₁ air bronchogram yes”, “I₂ notch no”, “I₃ corona radiata yes”, . . . , “Iₙ Involement(vessel) yes”, the characteristic values indicated by Vᵤ of the unknown case are Vᵤ={1, 0, 1, . . . , 1}.

In step S3010, the inference unit 106 in FIG. 1 infers the class to which the unknown case belongs based on the characteristic values Vᵤ of the unknown case (second characteristic values) that were obtained in step S3000 (first inference). In other words, the inference unit 106 obtains the inferred class of the unknown case by inference. This inference can be performed using, for example, various known inference techniques such as a Bayesian network, a neural network, or a support vector machine.

In the present embodiment, a Bayesian network is used as the inference technique. A Bayesian network is an inference model that employs conditional probabilities, and when characteristic values have been input, the Bayesian network can obtain an inference probability for each class (for each class, the probability that the case belongs to that class, which is also called a “posterior probability”). In the present embodiment, the class that has the highest inference probability among all of the classes is considered to be the inferred class. Specifically, the abnormal shadow type D1, D2, or D3 is obtained as the inferred class.

In step S3020, the similar case obtaining unit 104 selects, from among known cases that have been input from the database 200 to the inference apparatus 100, at least one case that is similar to the unknown case obtained in step S3000, and treats the selected cases as similar cases. The similar case obtaining unit 104 then outputs information regarding each of the selected similar cases (the case identifier, the characteristic values, the similarity to the unknown case, the correct class, the representative image, and the like) to the class obtaining unit 108 and the presentation unit 110.

Similar cases can be selected using various techniques, one example of which is a known technique in which the similarity in characteristic values between cases is calculated, and a designated number of similar cases are selected in order of descending similarity. The following describes a method employing “cos similarity” as one example. The method for obtaining similar cases and the method for calculating the similarity in characteristic values between cases are not intended to be limited to the methods given as examples, and any known technique for selecting similar cases may be used.

Given N-dimensional vectors V1 and V2, and letting Sim(V1,V2) indicate “cosign similarity” of the two vectors, Sim(V1,V2) is expressed by the following equation.

$$Sim ( V 1 , V 2 ) = \frac{V 1 \cdot V 2}{\vert V 1 \vert \vert V 2 \vert}$$

Here, V1·V2 indicates the inner product of the vectors V1 and V2, and |V1| and |V2| indicate the magnitude of the vector V1 and V2 respectively. The closer the value of Sim(V1,V2) is to 1, the more similar the two vectors are. Accordingly, assuming that V1 indicates the characteristic values of the unknown case (second characteristic values), and V2 indicates the characteristic values of a known case (first characteristic values), it is possible to calculate the similarity between the characteristic values of the unknown case and the known case.

For example, letting Vk1 and Vk2 indicate the characteristic values of two known cases, assume that |Vᵤ|=3.00, |Vk1|=|Vk2|=2.83, Vᵤ·Vk1=3.00, and Vᵤ·Vk2=7.00. In this case, the similarities between the unknown case and the known cases are Sim(Vᵤ,Vk1)=0.354, and Sim(Vᵤ,Vk2)=0.825, and therefore Vk2 is more similar to Vᵤ than Vk1 is. In the present embodiment, similarity to the unknown case is calculated for all of the known cases, and the five cases having the highest similarities are obtained as similar cases.

In step S3030, the class obtaining unit 108 infers the classes to which the similar cases belong based on the characteristic values Vkm of the similar cases (first characteristic values) that were selected in step S3020 (second inference). In other words, the class obtaining unit 108 obtains the inferred classes of the similar cases by inference, and obtains the inferred classes as the information regarding the classes of the similar cases. The inference method used here may be, for example, the same as that used by the inference unit 106 in step S3010.

In step S3040, the presentation unit 110 displays the information regarding the unknown case (e.g., characteristic values or representative image) that was obtained in step S3000 and the inferred class of the unknown case that was obtained in step S3010, on the monitor 1005. The presentation unit 110 also generates information based on the information regarding the classes of the similar cases that was obtained in step S3030, and displays the generated information on the monitor 1005. For example, the presentation unit 110 determines whether the inference results (inferred classes) of the similar cases obtained in step S3030 match the correct classes of the known cases obtained in step S3020 (i.e., whether the inferences are correct), and displays the determination results as information (correct/incorrect state 4006) in FIG. 4. The presentation unit 110 also includes a reliability calculation unit 112, and the reliability calculation unit 112 calculates the reliability of the inference regarding the unknown case based on the correct/incorrect states of the aforementioned inference results regarding the similar cases. The presentation unit 110 then displays the calculated reliability as information. The inference reliability referred to here can be, for example, the ratio between the correct/incorrect states of the inference results regarding the similar cases.

FIG. 4 shows an example of presentation information displayed on the monitor 1005 in the present embodiment. Presentation information 400 includes an image 4000 indicating the unknown case, unknown case characteristic values (finding information) 4001 that have been obtained in step S3000, and an unknown case inferred class 4002 that has been inferred in step S3010. The presentation information 400 furthermore includes identifiers 4003 that respectively identify similar cases selected in step S3020, similarities 4004 between the unknown case and each of the similar cases that have been calculated in step S3020, and inferred classes 4005 of the similar cases that have been inferred in step S3030.

The presentation information 400 also includes correct/incorrect states 4006 of the inference results regarding the similar cases, and a reliability 4007 of the inference with respect to the unknown case, which has been obtained based on the correct/incorrect states 4006. The presentation information 400 furthermore includes GUI buttons 4008 for displaying detailed information regarding the similar cases, and if one of the GUI buttons 4008 has been clicked by the mouse 1006, a window showing detailed information regarding the corresponding similar case (e.g., a representative image or characteristic values) is displayed. In the example in FIG. 4, the correct/incorrect state 4006 of an inference result is displayed as “M” (matched) if the inferred class and the correct class match, and as “U” (unmatched) if the inferred class and the correct class do not match. Also, in the example in FIG. 4, the inferred class and the correct class match in four cases out of the five (the predetermined number in the display area) similar cases, and therefore ⅘=0.800 is displayed as the reliability of the inference.

If the user has designated an information presentation method using a UI (not shown), the presentation unit 110 presents the above-described information with use of the designated presentation method. For example, instead of the inferred class 4005, information indicating whether or not the inferred class matches the correct class may be displayed, or the inferred class and the correct class may be displayed without displaying information indicating whether they match. Also, it is possible to display only the information regarding whether they match.

In the case where the user has designated a reliability calculation method using a UI (not shown), the reliability calculation unit 112 calculates the reliability with use of the designated calculation method. For example, a method of obtaining the reliability by performing weighted averaging on the correct/incorrect states with use of the similarities as weights can be selected as the method for calculating the reliability. In the example in FIG. 4, the reliability is (0.949×1+0.943×1+0.943×0+0.904×1+0.866×1)/5=0.732. Also, in the case of using an inference technique that can calculate inference probabilities, it is possible to select a method of obtaining the reliability by averaging the inference probabilities of the inferred classes that match the correct classes. Alternatively, it is possible to select a method of obtaining the reliability by performing weighted averaging on the inference probabilities of the inferred classes that match the correct classes with use of the similarities as weights. The method for calculating the reliability is not intended to be limited to the examples described above.

In this way, the user can estimate the performance of the inference apparatus 100 with respect to the similar cases that are similar to the unknown case by viewing the inferred class of the unknown case and the inferred classes and the correct/incorrect states of the inference results of the similar cases, thus enabling the reliability of the inference to be evaluated intuitively. Specifically, the inference apparatus according to the present embodiment obtains one or more similar cases that are similar to the unknown case, performs inference with respect to the unknown case and each of the similar cases, and presents information based on each of the inference results. This enables estimating the performance of the inference technique with respect to cases that are similar to the unknown case whose class is to be inferred, instead of the performance of the inference technique with respect to the known cases overall, thus making it possible to intuitively evaluate the reliability of the inference. Also, since there is no dependency on the inference method, it is possible to provide a mechanism for deriving the reliability of an inference with respect to each unknown case, regardless of the inference technique that is used.

### First Variation of the First Embodiment

In the first embodiment, the class obtaining unit 108 performs processing for calculating the inferred classes of similar cases in step S3030. In the case of a configuration where it is possible for the user to select processing parameters (the inference algorithm and other parameters) for the inference regarding the unknown case in step S3010, the inference regarding the similar cases may also be executed in accordance with the same processing parameters as those used in the inference regarding the unknown case as described above.

However, if the inference processing parameters are fixed (not selectable), or if the number of options is limited, a configuration is possible in which another apparatus performs the inference regarding the known cases in advance, and the results (inferred classes) of the inference are held in the database 200 in association with the respective known cases. Here, the processing in which the inference unit 106 of the inference apparatus 100 infers classes in step S3010 and the processing in which inference regarding the known cases is performed in advance may be the same processing. In other words, inference may be performed using the same processing parameters. In this case, in step S3030, it is sufficient for the class obtaining unit 108 to obtain, from the database 200, the inferred classes of the similar cases that were inferred using the same processing parameters as those in the inference regarding the unknown case, as the information regarding the classes of the similar cases. This enables omitting the inference regarding the similar cases, thus making it possible to accelerate the processing in step S3030.

Also, in this case, the inference apparatus 100 does not need to obtain the correct classes of the similar cases from the database 200. For example, the inference apparatus 100 may obtain, from the database 200, the inferred classes of the similar cases and the corresponding correct/incorrect states of the inference results (information indicating whether the inferred class matches the correct class), as the information regarding the classes of the similar cases. Also, it is possible for the inference apparatus 100 to obtain only information necessary for display from the database 200, and in the case of, for example, displaying only the information indicating the correct/incorrect states of the inference results, it is possible for the inference apparatus 100 to obtain only the information indicating the correct/incorrect states of the inference results from the database 200 as the information regarding the classes of the similar cases.

### Second Variation of the First Embodiment

Although the case where interpretation findings that can be expressed as yes or no are used as characteristic values is described in the first embodiment in order to simplify the description, any information regarding the cases may be used as the characteristic value. In the case of inferring the type of an abnormal shadow in a lung as in the example described above, the characteristic value may be, for example, a finding that can take a plurality of discrete values (e.g., whether the shape of a mass is circular, linear, lobulated, or irregular). Also, a finding that is input as numerical information, such as the size of the mass, may be used. Moreover, an image feature quantity regarding an abnormal shadow may be obtained by performing image processing on a medical image, and the obtained image feature quantity may be used as the characteristic value. Furthermore, clinical data regarding a case or the like (e.g., blood test results, age, or gender) may be used as the characteristic value.

### Second Embodiment

The example of a method for obtaining known cases having a high similarity as similar cases is described in the first embodiment. However, the method for obtaining similar cases is not limited to this, and another method may be used. An inference apparatus according to the present embodiment obtains, as similar cases, known cases having an inferred class that matches the inferred class of an unknown case. Also, similar cases whose inferred classes are correct are distinguished from similar cases whose inferred classes are incorrect when obtaining similar cases.

The configuration of the inference apparatus according to the present embodiment is similar to that shown in FIG. 1 of the first embodiment. The basic configuration of a computer that realizes the inference apparatus 100 by executing software is also similar to that shown in FIG. 2 of the first embodiment. Furthermore, a flowchart illustrating the overall processing performed by the inference apparatus 100 is similar to that shown in FIG. 3 of the first embodiment. Note that in steps S3020, S3030, and S3040, some of the processing performed by the inference apparatus 100 of the present embodiment is different from that in the first embodiment. Below is a description of portions of the inference apparatus according to the present embodiment that differ from the first embodiment.

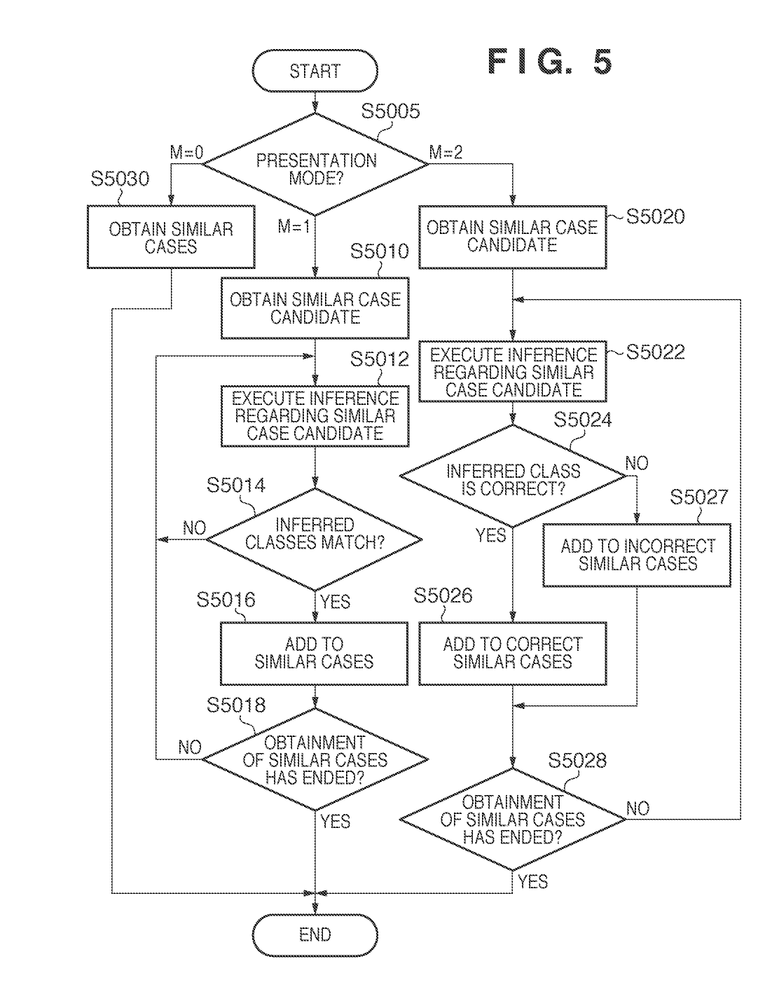

First is a description of exemplary processing for obtaining similar cases performed by the inference apparatus 100 in step S3020 with reference to the flowchart in FIG. 5. In step S5005, the inference apparatus 100 performs the following processing branching in accordance with the type of presentation method (presentation mode M) designated by the user with use of a UI (not shown). Specifically, if the user has selected the presentation mode “Display only similar cases whose inferred class matches the unknown case” (M=1), the inference apparatus 100 proceeds to the processing of step S5010. If the user has selected the presentation mode “Display similar cases with correct inferred classes and similar cases with incorrect inferred classes separately” (M=2), the inference apparatus 100 proceeds to the processing of step S5020. If neither of the above has been selected (M=0), the inference apparatus 100 proceeds to the processing of step S5030 and executes processing similar to that of step S3020 in the first embodiment as step S5030, and thereafter the processing ends.

In step S5010, the similar case obtaining unit 104 selects, from among the known cases that have been input to the inference apparatus 100, one or more cases that are similar to the unknown case obtained in step S3000, and treats the selected cases as similar case candidates. A technique similar to that of step S3020 can be used in this processing. In the present embodiment, the 20 cases having the highest similarities are obtained as similar case candidates. The similar case candidates obtained in this step are assumed to be sorted in descending order of similarity. Also, j is set to 1 as the initial value for performing the following steps. In the following steps, processing is executed in order beginning with the leading similar case candidate in the sorted order.

In step S5012, based on the characteristic values of the j-th similar case candidate, the inference apparatus 100 infers the class to which the similar case candidate belongs. Similarly to step S3010, the abnormal shadow type D1, D2, or D3 is obtained as the inferred class.

In step S5014, the inference apparatus 100 determines whether the inferred class of the unknown case obtained in step S3010 matches the inferred class of the j-th similar case candidate obtained in step S5012. If it has been determined that they match (“YES” in step S5014), the inference apparatus 100 executes the processing of step S5016. If it has been determined that they do not match (“NO” in step S5014), the inference apparatus 100 returns to step S5012 and sets j to j+1.

In step S5016, the inference apparatus 100 adds the j-th similar case candidate as a similar case. In step S5018, the inference apparatus 100 determines whether the obtainment of similar cases has ended. If it has been determined that obtainment has ended (“YES” in step S5018), the inference apparatus 100 ends the processing of step S3020. If it has been determined that obtainment has not ended (“NO” in step S5018), the inference apparatus 100 returns to step S5012 and sets j to j+1. In the present embodiment, the inference apparatus 100 determines that the obtainment of similar cases has ended when the number of similar cases has reached five.

The processing in step S5020 is similar to that in step S5010. Also, the processing in step S5022 is similar to that in step S5012. In step S5024, the inference apparatus 100 determines whether the inferred class of the j-th similar case candidate obtained in step S5022 matches the correct class of that similar case candidate. The inference apparatus 100 executes the processing of step S5026 upon determining that they match, that is to say, the inferred class is correct (“YES” in step S5024), and executes the processing of step S5027 upon determining that they do not match, that is to say, the inferred class is not correct (“NO” in step S5024).

In step S5026, the inference apparatus 100 adds the j-th similar case candidate as a correct similar case. Note that if the number of correct similar cases has already reached five, the inference apparatus 100 does not execute the processing for adding the correct similar case candidate. In step S5027, the inference apparatus 100 adds the j-th similar case candidate as an incorrect similar case. Note that if the number of incorrect similar cases has already reached five, the inference apparatus 100 does not execute the processing for adding the incorrect similar case candidate.

In step S5028, the inference apparatus 100 determines whether the obtainment of similar cases has ended. If it has been determined that obtainment has ended (“YES” in step S5028), the inference apparatus 100 ends the processing of step S3020. If it has been determined that obtainment has not ended (“NO” in step S5028), the inference apparatus 100 returns to step S5022 and sets j to j+1. In the present embodiment, the inference apparatus 100 determines that the obtainment of similar cases has ended when the number of correct similar cases and the number of incorrect similar cases have both reached five.

The processing in step S3020 of the present embodiment is executed as described above. If the presentation mode M is 1 or 2, the inferred classes of the similar cases have already been calculated in the processing of step S3020, and therefore the processing performed by the class obtaining unit 108 in step S3030 is processing for only obtaining the inferred classes of the similar cases from the similar case obtaining unit 104. On the other hand, if M is 0, the processing of step S3030 is similar to that of the first embodiment.

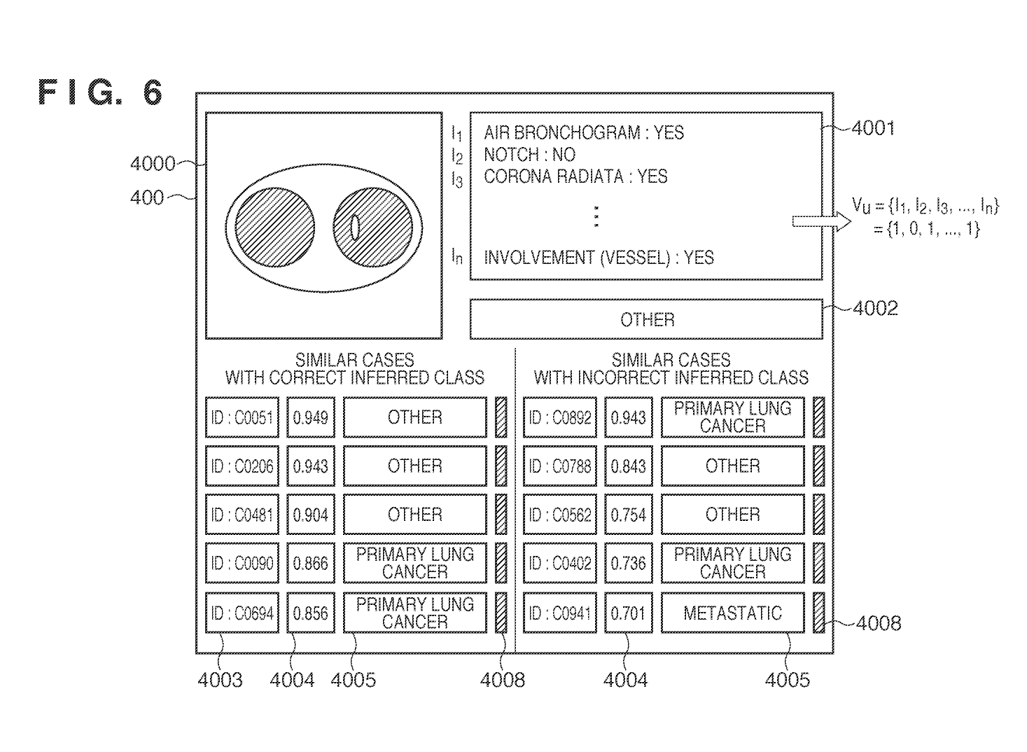

FIG. 6 shows an example of presentation information displayed on the monitor 1005 in the case where the presentation mode M is 2 in the processing in step S3040 of the present embodiment. As shown in FIG. 6, if M is 2, the similar cases whose inferred classes are correct and the similar cases whose inferred classes are incorrect are displayed in separate groups. The information displayed in the case where M is 0 or 1 is similar to that shown in FIG. 4, and a description thereof has thus been omitted. Note that if M is 1, the inferred classes 4005 of the similar cases may be omitted from the display since they are all the same as the inferred class of the unknown case.

According to the inference apparatus of the present embodiment, the user can see whether or not inference results are correct for similar cases whose inferred classes are the same as the inferred class of the unknown case. Accordingly, the similar cases are limited to only those “having the same inferred class as the unknown case”, and in this state the user can estimate the performance of the inference apparatus 100 with respect to the similar cases that are similar to the unknown case, thus enabling the reliability of the inference to be evaluated intuitively.

The user can also become aware of a tendency of the inference apparatus 100 to infer correctly or incorrectly with respect to the similar cases that are similar to the unknown case, thus making it possible to evaluate whether the inference regarding the unknown case is to be used as a reference. The variations described in the first embodiment are applicable to the second embodiment as well.

### Third Embodiment

The example of a method for displaying the classes of the unknown case and the similar cases, which are the inference results, as presentation information is described in the first embodiment. However, depending on the inference technique that is used, it is possible to calculate the inference probability of the inference results, and in such a case, presentation information that is based on the inference probabilities may be obtained. The configuration of an inference apparatus according to the present embodiment is similar to that shown in FIG. 1 of the first embodiment. The basic configuration of a computer that realizes the inference apparatus 100 by executing software is also similar to that shown in FIG. 2 of the first embodiment. Note that only some of the processing performed by the presentation unit 110 differs from that of the first embodiment. Also, a flowchart illustrating the overall processing performed by the inference apparatus 100 is similar to that shown in FIG. 3 of the first embodiment. Note that only some of the processing of step S3040 differs from that of the first embodiment. Below is a description of portions of the inference apparatus according to the present embodiment that differ from the first embodiment.

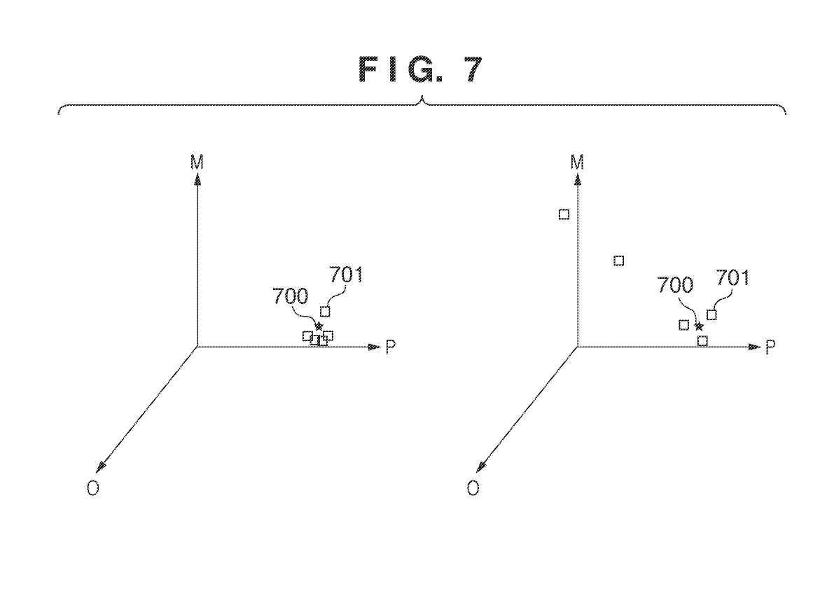

In step S3040, the presentation unit 110 generates information based on the inference results regarding the similar cases that were obtained in step S3030, and displays the generated information on the monitor 1005. FIG. 7 shows an example of presentation information in the present embodiment. The presentation information is displayed in a three-dimensional coordinate system in which the inference probability of “primary lung cancer” is plotted on the P axis, the inference probability of “metastatic cancer to the lungs” is plotted on the M axis, and the inference probability of “other” is plotted on the O axis. In this three-dimensional coordinate system, a star sign 700 indicates the unknown case, and square signs 701 indicate similar cases. If the unknown case and the similar cases cluster together as shown on the left side in FIG. 7, this shows that the characteristic value group is a characteristic value group for which inference is simple. On the other hand, if the inference probabilities of the unknown case and the similar cases are scattered as shown on the right side in FIG. 7, this shows that the characteristic group is a characteristic value group for which inference is difficult. This therefore suggests that the reliability of the inferences in the input information shown on the left side in FIG. 7 is higher than that in the input information shown on the right side in FIG. 7.

According to the method described above, displaying the inference probabilities of the cases on a graph enables becoming aware of how simple it is to make an inference with respect to the characteristic value group of the unknown case and the similar cases, thus making it possible to evaluate the reliability of the inference.

### First Variation of the Third Embodiment

A method for displaying presentation information as a graph is described in the third embodiment. However, the presentation information does not need to be displayed as only a graph. For example, the presentation information shown in FIG. 4, which is an example of presentation information in the first embodiment, may be displayed at the same time.

### Second Variation of the Third Embodiment

A method for creating a graph in the case of three classes is described in the third embodiment. However, there may be any number of classes. Here, if there are two classes, the presentation information may be displayed linearly. Also, the presentation information may be displayed using a hyperplane if there are three or more classes, or using a hypercube if there are four or more classes. Note that the variations described in the first embodiment are applicable to the present embodiment as well.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-044633, filed Mar. 1, 2010, which is hereby incorporated by reference herein in its entirety.

What is claimed is:

1. An inference apparatus that infers a class of a case, comprising:
an inference unit configured to infer a class of a case with use of an inference device; and
an evaluation unit configured to, based on a result of inference performed by the inference device with respect to a known case that is similar to an unknown case, evaluate a result of inference with respect to the unknown case.

2. The apparatus according to claim 1, wherein the evaluation unit evaluates the result of inference performed by the inference device with respect to the unknown case, based on a degree of matching between an attribute inferred by the inference device with respect to a known case that is similar to the unknown case and has a known attribute, and the known attribute of the known case.

3. The apparatus according to claim 1, further comprising:
a storage unit configured to, for each of a plurality of known cases, store a characteristic value representing the known case and a class to which the known case belongs; and
a selection unit configured to select, from the storage unit, a known case for which a similarity between a characteristic value representing the unknown case and the characteristic value representing the known case is in a predetermined range,
wherein the evaluation unit evaluates the result of inference performed by the inference device with respect to the unknown case, based on, for each of the selected known cases, a degree of matching between a class of the known case inferred by the inference device with use of the characteristic value of the known case and the class of the known case stored in the storage unit.

4. The apparatus according to claim 3, further comprising a display control unit configured to cause a display unit to display, from among the known cases selected by the selection unit, a known case for which the class inferred by the inference device with respect to the known case matches the class inferred with respect to the unknown case.

5. The apparatus according to claim 3, further comprising a display control unit configured to cause a display unit to display, from among the selected known cases, a known case for which the inferred class of the known case matches the stored class of the known case, and a known case for which the inferred class of the known case does not coincide with the stored class of the known case, in a distinguishable manner.

6. The apparatus according to claim 1, wherein a known class of a known case that is similar to the unknown case matches a class to which the unknown case belongs.

7. An inference method for inferring a class of a case, comprising:
inferring a class to which an unknown case belongs with use of an inference device; and
calculating a reliability of the inferred class based on a result of inference performed by the inference device with respect to a known case that is similar to the unknown case.

8. A computer program stored in a computer-readable storage medium for causing a computer to execute the steps of the inference method according to claim 7.
